(19) United States
(12) Patent Application Publication
(10) Pub. No.: US 2014/0137159 A1
(43) Pub. Date: May 15, 2014

(54) SYSTEM AND METHOD FOR USING A USER DEVICE TO SELECT AND WIRELESSLY RECEIVE TELEVISION AUDIO

(71) Applicant: Michael C. Ryan, Mitchellville, IA (US)

(72) Inventor: Michael C. Ryan, Mitchellville, IA (US)

(21) Appl. No.: 14/077,154

(22) Filed: Nov. 11, 2013

Related U.S. Application Data
(60) Provisional application No. 61/724,737, filed on Nov. 9, 2012.
(60) Provisional application No. 61/725,002, filed on Nov. 11, 2012.

(51) Int. Cl. H04N 21/472; H04N 21/4363

(52) U.S. Cl. CPC H04N 21/472; H04N 21/43637
USPC 725/59

(57) ABSTRACT

Systems and methods for using a cell phone to select and wirelessly receive audio from a display in a multi-display environment are provided.

### PRIORITY CLAIM

The present invention claims priority to and the benefit of U.S. Provisional Application No. 61/725,002, entitled “The Systems and Methods for Employing Your Cell Phone WiFi Radio to Selectively Choose From A Group of Television Sets That Are Networked Together and Grouped in a Sports Bar, Lounge, Restaurant, Airport Terminal, Convention Center, Museum or the Like and to Wirelessly Receive Through the WiFi Radio of Your Cell Phone the Audio Broadcast of Your Selected Television Set That is Broadcasting Your Selected Broadcast from the List of Networked TVs Displayed on Your Phone,” filed on Nov. 11, 2012 and U.S. Provisional Application No. 61/724,737, entitled “The Systems and Methods for Employing Your Cell Phone Bluetooth Radio to Selectively Choose From A Group of Television Sets Grouped in a Sports Bar, Lounge, Restaurant, Airport Terminal, Convention Center, Museum or the Like and to Wirelessly Receive Through the Bluetooth Radio of Your Cell Phone the Audio Broadcast of Your Selected Television Unit That is Broadcasting Your Selected Broadcast, filed on Nov. 9, 2012, both by Inventor Michael C. Ryan, the contents of which are incorporated herein by reference.

### BACKGROUND OF THE INVENTION

1. Field of the Invention

The present invention is generally related to mobile telecommunications. More particularly, the present invention pertains to a system and method for using a user device to select and wirelessly receive television audio in a multi-display environment.

2. Introduction

Various venues, especially restaurants and sports bars, provide television viewing to its patrons. In many establishments, multiple televisions are displaying the various sporting or entertainment events of the day. For example, a venue such as a sports bar may display a football game on a main television while at the same time displaying baseball, soccer, racing, etc. on other television sets throughout the venue. In many cases, only the audio is available for one of the displays. The audio is turned down for all other displays in the venue. As a result, enjoyment of events that have their audio turned off is lessened.

Venues simply turn off all audio or must determine which event will be the most popular throughout the day and make sure that display's audio is turned on. However, a venue wants to please as many patrons as possible and not lose business simply because the audio for a patron's selected event is not available. What is needed is a method and system to enable patrons to access audio for a particular display of interest in a multi-display environment.

### SUMMARY OF THE INVENTION

While the way in which the present invention addresses the disadvantages of the prior art will be discussed in greater detail below, in general, the present invention are systems and methods for using a cell phone to select and wirelessly receive audio in a multi-display environment.

A method for using a user device to select and wirelessly receive audio in a multi-display environment comprises the steps of accessing a wireless network by a user device, receiving at the user device a list of one or more audio/visual devices accessible by the network, selecting from the list at the user device one of the audio/visual devices, and receiving an audio stream from the selected audio/visual device.

A system for using a user device to select and wirelessly receive audio in a multi-display environment comprises a short range network, a user device configured to communicate over a short range network, and an audio/visual device configured to communicate over the short range network wherein upon request from the user device through the short range network, the audio/visual device streams audio to the user device over the short range network.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary venue of the present invention.

FIG. 2 illustrates an exemplary method of using a user device to select and wirelessly receive audio in a multi-display environment.

FIG. 3 illustrates an exemplary embodiment of a system for selecting and wirelessly receiving audio at a user device in a multi-display environment.

### DETAILED DESCRIPTION OF THE INVENTION

Various embodiments of the invention are described in detail below. While specific implementations involving electronic portable or mobile devices (e.g., smart phones) are described, it should be understood that the description here is merely illustrative and not intended to limit the scope of the various aspects of the invention. A person skilled in the relevant art will recognize that other components and configurations may be easily used or substituted than those that are described here without parting from the spirit and scope of the invention.

The present invention facilitates receiving audio at a user device from an audio/visual device in a multi-display environment. For the sake of brevity, conventional data networking, application development and other functional aspects of the systems (and components of the individual operating components of the systems) may not be described in detail. The connecting lines shown in the various figures are intended to represent exemplary functional relationships and/or physical couplings between various elements. It should be noted that many alternative or additional functional relationships or physical connections might be present in a practical system.

The invention may be described in terms of functional block components, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, audio and/or visual elements, input/output elements, wired or wireless communication techniques, and the like, which may carry out a variety of functions under the control of one or more microprocessors or other control devices.

Similarly, the software elements of the invention may be implemented with any programming, scripting language or web service protocols such as C, C++, C#, Java, COBOL, assembler, and the like. As those skilled in the art will appreciate, the software and hardware elements may be implemented with an operating system such as Microsoft Windows®, Microsoft Mobile, UNIX, Apple OS X, MacOS, Apple iOS, Android, Linux, and the like. Software elements may also include utilizing the services of a cloud-based platform or software as a service (SaaS) to deliver functionality to the various system components.

As will be appreciated by one of ordinary skill in the art, the system may be embodied as a customization of an existing system, an add-on product, upgraded software, a stand-alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, DVDs, optical storage devices, magnetic storage devices, solid state storage devices and/or the like.

The computer program instructions may be loaded onto a general purpose computer, special purpose computer, or other programmable data processing apparatus to produce a machine, such that the instructions execute on the computer or other programmable data processing apparatus and create means for implementing the functions specified in the flowchart block or blocks. The computer program instructions may also be loaded onto a computer or other programmable data processing apparatus to cause a series of operational steps to be performed on the computer or other programmable apparatus to produce a computer-implemented process such that instructions which execute on the computer or other programmable apparatus provide steps for implementing the functions specified in the flowchart block or blocks.

As used herein, the term “network” shall include any electronic communications means which incorporates both hardware and software components. Communication among the systems may be accomplished through any suitable communication channels, such as, for example, a telephone network, an extranet, an intranet, Internet, portable computer device, personal digital assistant, online communications, satellite communications, off-line communications, wireless communications, transponder communications, local area network, wide area network, networked or linked devices, keyboard, mouse and/or any suitable communication or data input modality. Exemplary embodiments utilize a Bluetooth communication network.

Today's phone devices have the ability to operate on a short range wireless network. A phone device may communicate with another device over a short range wireless network established between the devices. In many instances, audio may be streamed from one device to a phone device over the short range wireless network established between the devices. One exemplary short range network is a Bluetooth network. An exemplary audio profile defining how audio may be streamed over a Bluetooth connection is the Advanced Audio Distribution Profile (A2DP). The Bluetooth network and A2DP profile are well known and will not be explained in detail. Usually the establishment of the short range network is automatic and seamless to the user of the device. In accordance with the principles of the invention, a user is able to access an audio associated with a single display amongst a multi-display environment.

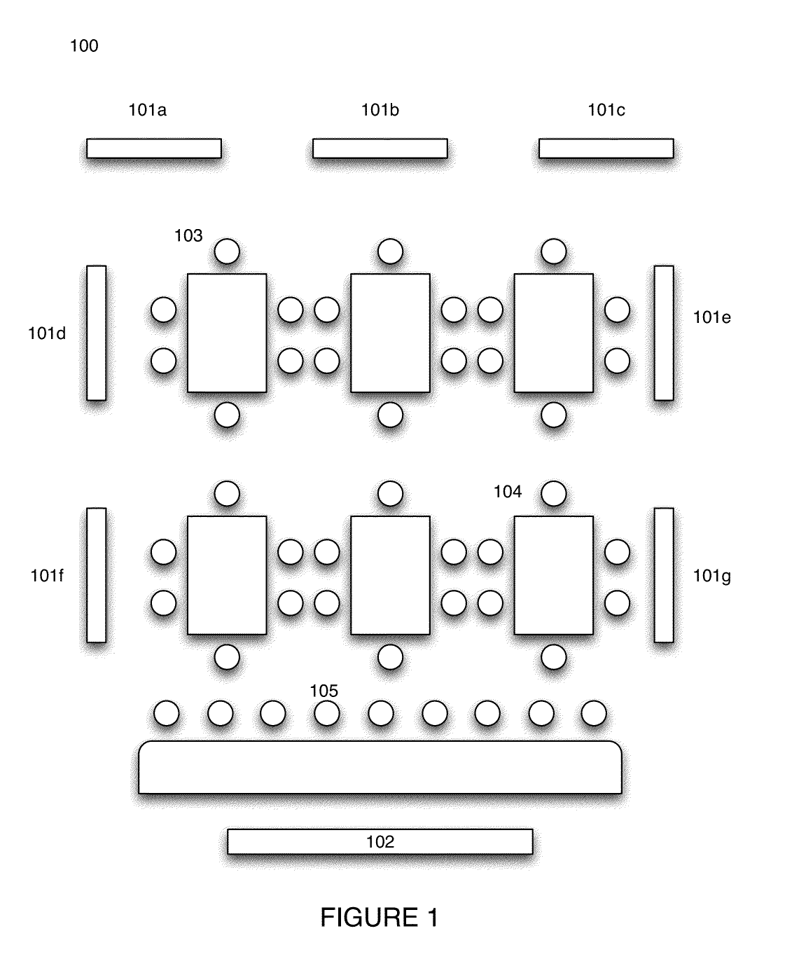

FIG. 1 illustrates, an exemplary venue in which the present invention may operate. A venue may include any location where a user may want to hear the audio associated with a display in a multi-display environment. Suitable venues may include restaurants, sports bars, lounges, airport terminals, convention centers, museums, arenas, sports fields, zoos or other similar locations that may employ multiple displays throughout the venue.

In one exemplary embodiment, the venue is a restaurant 100 with a multi-display environment. The restaurant 100 includes one main audio/visual display 102 and seven ancillary audio/visual displays 101a-101g. Patrons of the restaurant 100 are situated within the middle of the various displays and can view any of the displays. Typically, however, the main display 102 is the only display for which the patrons can hear the audio. In its embodiments, the present invention enables a patron 103 to access the audio of a particular display of interest, e.g., display 101d. At the same time, other patrons 104 and 105, are able to access the audio of displays 101g and 102, respectively.

In another embodiment, the venue may include a convention center or similar venue in which patrons are not static. Patrons may move throughout the venue encountering various displays. As a patron moves through the venue, the present invention enables the patron to access the desired audio of its associated display. As the patron continues to move throughout the venue, the present invention enables the patron to discontinue receiving audio from one display and access another audio broadcast associated with a different display.

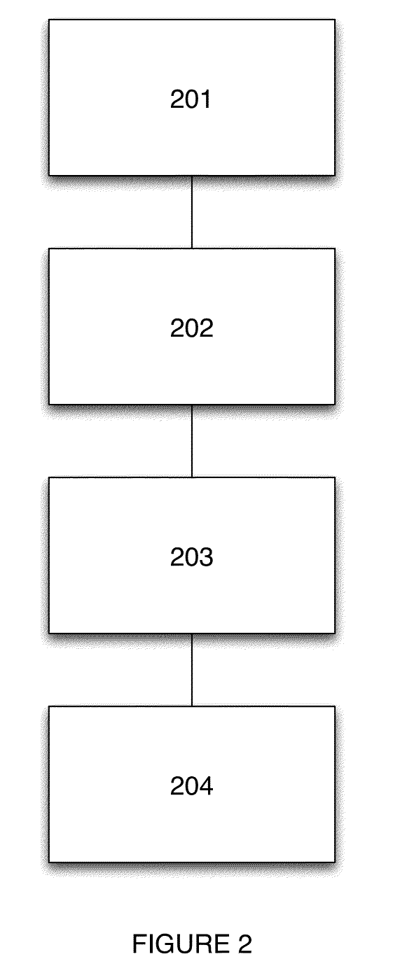

FIG. 2 illustrates an exemplary method of using a user device to select and wirelessly receive audio in a multi-display environment. In this method, selecting and wirelessly receiving audio in a multi-display environment comprising the steps of accessing a wireless network by a user device, the user device having a display screen 201, receiving at the user device a list of one or more audio/visual devices accessible by the network and displaying the list on the display screen 202, selecting from the list at the user device one of the audio/visual devices 203, and receiving an audio stream from the selected audio/visual device.

In its embodiments, accessing a wireless network by a user device may be through various protocols such as WiFi and/or Bluetooth. Any short range network now known or hereafter discovered are suitable and within the spirit of the presenting invention. Once the network becomes aware of the user device, a list of available audio/visual devices is transmitted to the user device. An available audio/visual device is one that is current displaying video within a venue and has the ability to wirelessly send its associated audio over the network. Converting an audio/visual device's audio stream so that it may be transmitted wirelessly is well known in the art and will not be explained here. However, in some embodiments, a device separate from the audio/visual device, for example, a converter box, may need to be connected to the audio/visual device so that the device may transmit its audio wirelessly. These devices are well known in the art and will not be explained here.

Once the user device receives the available audio/visual devices, the user may access the list through a user interface display on the device's display screen. Selection of one of the devices is dependent on the type of user device; however, such selection may be accomplished via touch screen, stylus, keyboard/pad, voice recognition, or a combination thereof. Once the selection is made, the audio/visual device is notified and transmits or otherwise makes available its audio signal over the network to the user device. The user device receives and plays the wireless audio.

In some embodiments, the network or audio/visual device may request authentication from the requesting user device. In other embodiments, selection of an available audio/visual device may include utilizing an infrared transceiver on the user device. The audio/visual device selection is accomplished by pointing the user device's infrared transceiver at the desired audio/visual device's infrared transceiver. The selected audio/visual device would respond by initiating the audio to the user device. In an exemplary embodiment, the infrared selection process includes exchanging identification information.

In some embodiments, the user interface on the user device may display the available audio/visual devices in list form. Each audio/visual device is identified and the user simply selects the desired list entry. In another embodiment, a visual representation of the venue and/or the audio/visual devices within the venue may be display (e.g., an icon). The user may simply choose the icon to initiate the receipt of audio.

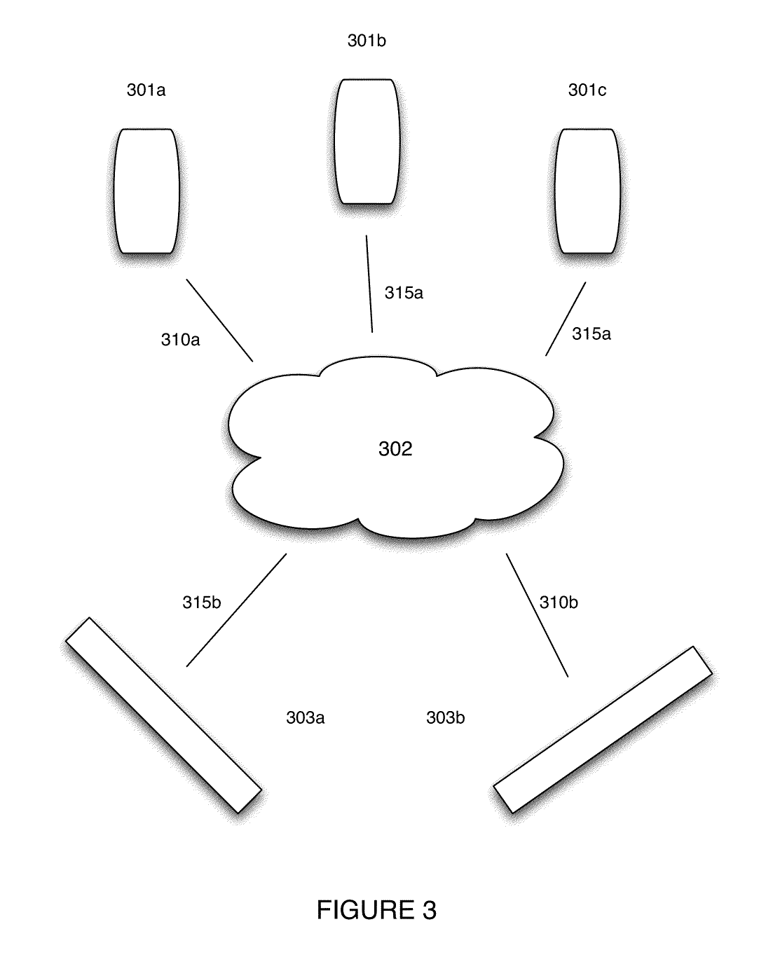

FIG. 3 illustrates an exemplary embodiment of a system for using a user device to select and wirelessly receive audio in a multi-display environment. FIG. 3 illustrates three user devices, 301a-301c, within a short range network 302. Devices 301a-301c may be any type of device configured to wirelessly receive audio over a short range network. In this exemplary embodiment, devices 301a-301c are cell phones. The short range network may be any network capable of streaming audio from audio/visual devices to a user device. The environment in which the present invention is used may determine the network employed. In this exemplary environment, the short range network is a Bluetooth network utilizing Advanced Audio Distribution Profiles (A2DP) that define how multimedia may be streamed over a Bluetooth connection. Bluetooth and the A2DP profiles are well known in the art and will not be explained here.

Audio/visual devices within the venue connected to the short range network and are able to receive requests from various user devices. In this exemplary embodiment, the audio/visual devices are television displays. Typically, within a venue such as a restaurant that employs multiple displays, only one display's audio is broadcast in the venue. FIG. 3 illustrates three cell phones connecting with network 302 and requesting either display 303a's or display 303b's audio. User device 301a makes a request (310a) for display 303b's audio over the network 302. Display 303b transmits its audio (310b) back through the network to the device. Such functionality is not limited to one user device to one display, but a display may transmit its audio to as many devices as the protocol and network will allow. FIG. 3 also illustrates devices 301b and 301c requesting and receiving (315a and 315b, respectively) audio from the single display 303b.

Although the above description may contain specific details, they should not be construed as limiting the claims in any way. Other configurations of the described embodiments of the invention are part of the scope of this invention. The descriptions and embodiments are not intended to be an exhaustive or to limit the invention to the precise forms disclosed. Accordingly, the appended claims and their legal equivalents should only define the invention, rather than any specific examples given.

What is claimed is:

1. A method for using a user device to select and wirelessly receive audio in a multi-display environment, the method comprising the steps of:
accessing a wireless network by a user device, the user device having a display screen;
receiving at the user device a list of one or more audio/visual devices accessible by the network and displaying the list on the display screen;
selecting from the list at the user device one of the audio/visual devices;
receiving an audio stream from the selected audio/visual device.

2. The method of claim 1, wherein the user device is a cell phone.

3. The method of claim 1, wherein the audio/visual device is a television set.

4. The method of claim 1, wherein the wireless network is a Bluetooth network.

5. The method of claim 1, wherein the wireless network is a WiFi network.

6. The method of claim 4, wherein the audio is streamed according to an Advanced Audio Distribution Profile.

7. A system for using a user device to select and wirelessly receive audio in a multi-display environment:
a short range network;
a user device configured to communicate through the short range wireless network;
an audio/visual device configured to communication through the short range wireless network and wherein upon request from the user device through the short range network, the audio/visual device streams audio to the user device over the short range network.

8. The system of claim 7, wherein the user device is a cell phone.

9. The system of claim 7, wherein the audio/visual device is a television set.

10. The system of claim 7, wherein the short range network is a Bluetooth network.

11. The system of claim 1, wherein the short range network is a WiFi network.

12. The system of claim 10, wherein the audio is streamed according to an Advanced Audio Distribution Profile.
